(19) United States
(12) Patent Application Publication
(10) Pub. No.: US 2020/0002905 A1
(43) Pub. Date: Jan. 2, 2020

(54) ROADWAY CROSSOVER APPARATUS

(71) Applicant: Red Dirt Mfg., LLC, Stillwater, OK (US)

(72) Inventors: Rodney Dean Brakhage, Stillwater, OK (US); Chad Clinton Kucko, Stillwater, OK (US)

(21) Appl. No.: 16/020,308

(22) Filed: Jun. 27, 2018

(51) Int. Cl. E01D 18/00; E01D 15/12; F16L 1/06

(52) U.S. Cl. CPC E01D 18/00; E01D 2101/40; F16L 1/06; E01D 15/12

(57) ABSTRACT

A roadway crossover apparatus includes a first manifold having at least one fluid inlet and a plurality of fluid outlets, a second manifold having a plurality of fluid inlets and at least one fluid outlet, and a plurality of polymeric tubes. Each polymeric tube has a first end fluidically connected to one of the fluid outlets of the first manifold and a second end fluidically connected to a corresponding one of the fluid inlets of the second manifold so the polymeric tubes extend between the first manifold and the second manifold with the first manifold and the second manifold spatially disposed relative to one another and the polymeric tubes spatially disposed relative to one another to permit a vehicle to pass over the polymeric tubes between the first manifold and the second manifold when the first manifold and the second manifold are positioned on a roadway.

### BACKGROUND

Hydraulic fracturing is a process used in the oil and gas industry to stimulate the production rate of a well. The process involves injecting a high volume of fluid, such as water, down the well at a high pressure to cause the subterranean formation surrounding the well to fracture. Because oil and gas wells are often in remote locations, one issue faced when performing hydraulic fracturing is how to effectively transport large quantities of fluid to the well site. One way of providing fluid is to transport the fluid in trucks to the well site. Due to the volume of fluid that may be required, this can be cost prohibitive. Another way of getting fluid to the well site is to pump the fluid through a conduit from a nearby source of fluid, such as a pond, lake, stream, or the like, to the well site.

Prior to initiating the pumping process, the conduit must be deployed from the well site to the source of fluid. Often, the distance from the fluid source to the well site may be several miles. Polymer based piping and metal based piping have been used to form the conduit. However, in recent years collapsible lay-flat hose have been used. In either case, the conduit must likely crossover one or more roadways between the fluid source and the well site. Because of the volume of fluid required to be transported, the conduits are relatively large, and thus it can be difficult for many vehicles to travel over the conduits. In addition, vehicles repeatedly traveling over the conduits can damage them.

Numerous devices have been proposed that facilitate the passage of a vehicle over a conduit while protecting the conduit from damage. Some devices are in the form of a reinforced section of conduit positioned on the roadway and others are in the form of a ramp structure positioned around the conduit. A problem encountered with both types of devices is they are generally heavy and large in size. As such, it is costly to transport the devices. Often, heavy equipment, such as a crane, must load and unload the devices from a trailer and to position and remove the devices from the roadway. With the devices forming a ramp structure, it can be difficult for a vehicle to drive over them because they are positioned around the conduit and thus add extra height.

To this end, a need exists for an improved roadway crossover apparatus. It is to such apparatus that the inventive concepts disclosed herein are directed.

### BRIEF DESCRIPTION OF THE DRAWINGS

Like reference numerals in the figures represent and refer to the same or similar element or function. Implementations of the inventive concepts disclosed may be better understood when consideration is given to this detailed description thereof. Such description references to the annexed pictorial illustrations, schematics, graphs, drawings, and appendices. In the drawings:

FIG. 1 is a perspective view of a roadway crossover apparatus constructed in accordance with the inventive concepts disclosed herein.

FIG. 2A is a perspective view of the roadway crossover apparatus of FIG. 1 shown with a pair of mats removed to illustrate a plurality of ramp assemblies.

FIG. 2B is a perspective view of the roadway crossover apparatus illustrating the ramp assemblies in a storage position.

FIG. 3 is a front elevational view of the roadway crossover apparatus of FIG. 2.

FIG. 4 is a side elevational view of the roadway crossover apparatus of FIG. 2.

FIG. 5 is a sectional view taken along line 5-5 of FIG. 2.

FIG. 6 is a cross sectional view of a polymeric tube.

FIG. 7 is a front perspective view of a clamp assembly.

FIG. 8 is a rear perspective view of a portion of the clamp assembly of FIG. 7.

### DETAILED DESCRIPTION OF EXEMPLARY EMBODIMENTS

The inventive concepts disclosed are generally directed to a roadway crossover apparatus connectable between two fluid conduits to convey fluid across a roadway. The roadway crossover includes a first manifold having at least one fluid inlet and a plurality of fluid outlets; a second manifold having a plurality of fluid inlets and at least one fluid outlet; and a plurality of polymeric tubes, each polymeric tube having a first end fluidically connected to one of the fluid outlets of the first manifold and a second end fluidically connected to a corresponding one of the fluid inlets of the second manifold so the polymeric tubes extend between the first manifold and the second manifold with the first manifold and the second manifold spatially disposed relative to one another and the polymeric tubes spatially disposed relative to one another to permit a vehicle to pass over the polymeric tubes between the first manifold and the second manifold when the first manifold and the second manifold are positioned on a roadway, the polymeric tubes having angular deflection characteristics and memory which permit the polymeric tubes to be angularly deflected by pressures exerted thereon and restored to a substantially non-deflected position upon removal of such pressures.

Before explaining at least one embodiment of the inventive concepts disclosed, it is to be understood that the inventive concepts are not limited in their application to the details of construction and the arrangement of the components or steps or methodologies in the following description or illustrated in the drawings. The inventive concepts disclosed are capable of other embodiments or of being practiced or carried out in various ways. Also, it is to be understood that the phraseology and terminology employed is for description only and should not be regarded as limiting the inventive concepts disclosed and claimed herein.

In this detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features may not be described to avoid unnecessarily complicating the disclosure.

Further, unless stated to the contrary, “or” refers to an inclusive “or” and not to an exclusive “or.” For example, a condition A or B is satisfied by anyone of: A is true (or present) and B is false (or not present). A is false (or not present) and B is true (or present), and both A and B are true (or present).

In addition, use of the “a” or “an” are employed to describe elements and components of the embodiments herein. This is done merely for convenience and to give a general sense of the inventive concepts disclosed. This description should be read to include one or at least one and the singular also includes the plural unless it is obvious that it is meant otherwise.

As used herein any reference to “one embodiment” or “an embodiment” means that a particular element, feature, structure, or characteristic described in the embodiment is included in at least one embodiment. The appearances of the phrase “in one embodiment” in various places in the specification are not necessarily all referring to the same embodiment.

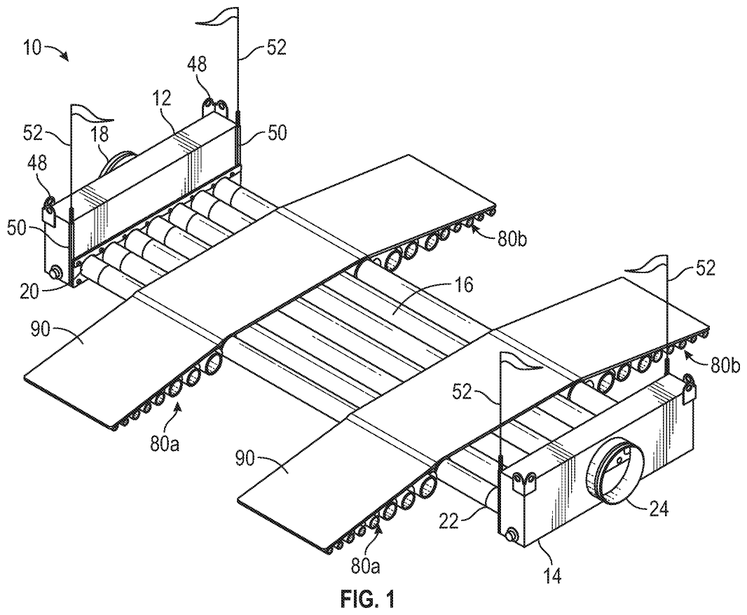

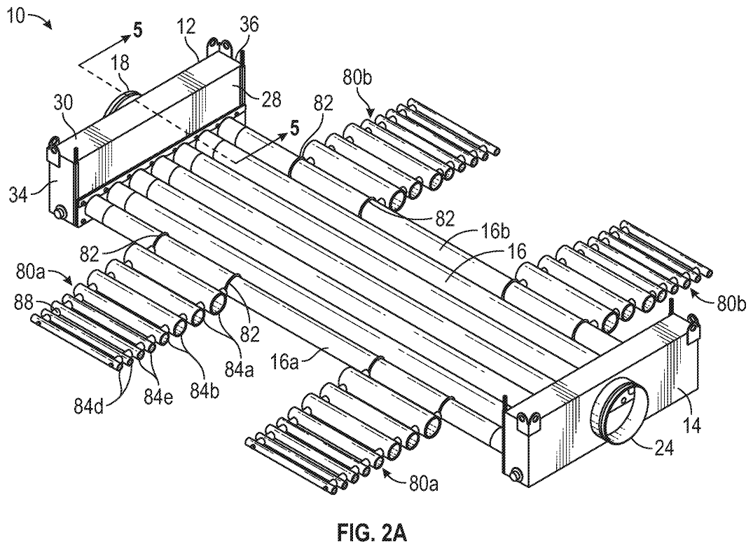

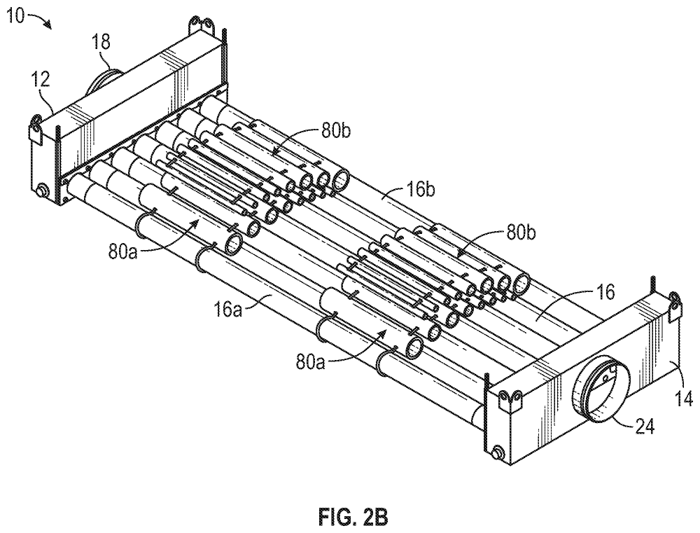

Referring now to the drawings, and more particularly to FIGS. 1 and 2, a roadway crossover apparatus 10 constructed in accordance with the inventive concepts disclosed herein is illustrated. The roadway crossover apparatus 10 is used for conveying fluid, (e.g., oil, water, and gas) over a roadway between two fluid conduits. The fluid conduits may be any type of conduits suitable for conveying fluids. Examples include hoses, lay flat hoses, and pipelines. Broadly, the roadway crossover apparatus 10 includes a first manifold 12, a second manifold 14, and a plurality of tubes 16 positioned between, and fluidically connected, to the first manifold 12 and the second manifold 14. The tubes 16 are spatially disposed relative to one another to permita vehicle to pass over the tubes 16 between the first manifold 12 and the second manifold 14 when the first manifold 12 and the second manifold 14 are positioned on a roadway. The tubes 16 have angular deflection characteristics and memory which permit the tubes 16 to be angularly deflected by pressures exerted thereon and restored to a substantially non-deflected position upon removal of such pressures.

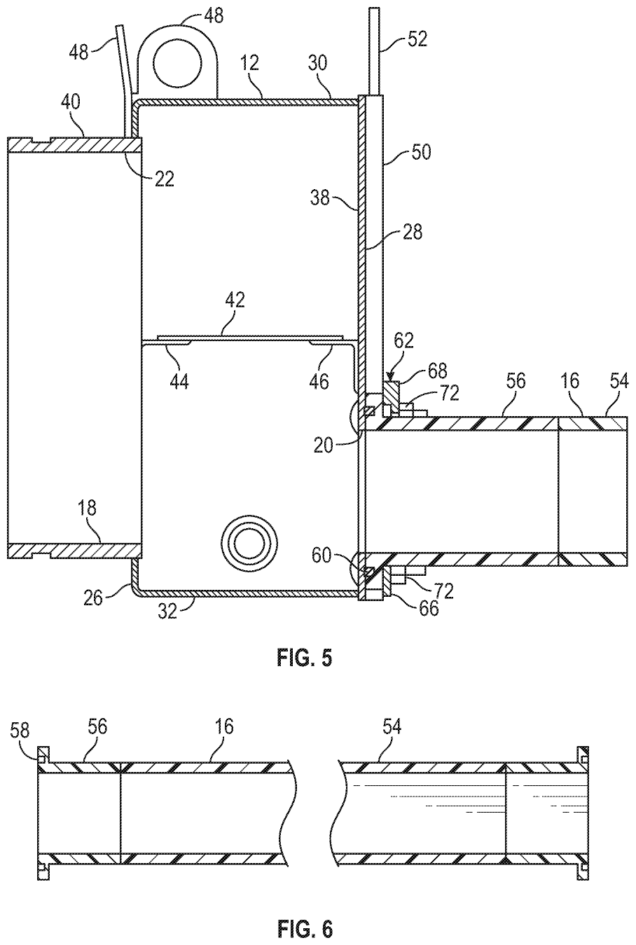

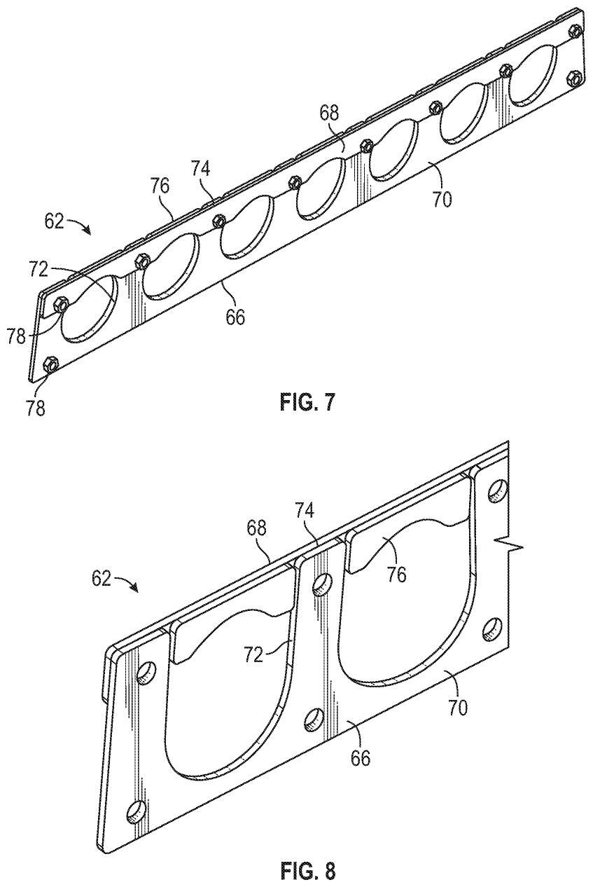

Referring now to FIGS. 1, 2, and 3-5, the first manifold 12 has at least one fluid inlet 18 and a plurality of fluid outlets 20. Conversely, the second manifold 14 has a plurality of fluid inlets 22 and at least one fluid outlet 24. The first manifold 12 is identical in construction to the second manifold 14. How the fluid inlets and fluid outlets are designated depends on whether the manifold is positioned on an upstream side of the roadway crossover apparatus 10 or on a downstream side of the roadway crossover apparatus 10. Because the first manifold 12 and the second manifold 14 are identical in construction, only the first manifold 12 will be described in detail.

In one embodiment, the first manifold 12 is substantially rectangular in shape and has a front wall 26, a rear wall 28, a top wall 30, a bottom wall 32, a first end wall 34, and a second end wall 36 defining a fluid chamber 38 in fluidic communication with the fluid inlet 18 and the fluid outlets 20. The fluid inlet 18 extends through the front wall 26. A hose fitting 40 is connected to the front wall 26 to further define the fluid inlet 18 and to permit a hose (not shown) to be connected to the first manifold 12. In one exemplary version, the hose fitting 40 may be sized to receive a twelve inch hose. In another exemplary version, the first manifold 12 may include two or more fluid inlets sized to receive ten inch hoses. The number and size of the fluid inlets 18 may be varied.

The fluid outlets 20 of the first manifold 12 are formed in the rear wall 28. The rear wall 28 is shown to have seven fluid outlets 20, but the number of fluid outlets may be varied to accommodate a desired fluid volume. In one version, the fluid outlets 20 have a diameter of about four inches, but the dimensions of the fluid outlets 20 may be varied. The first manifold 12 may also include a drain hole covered with a removable plug 41 (shown formed in the first end wall 34).

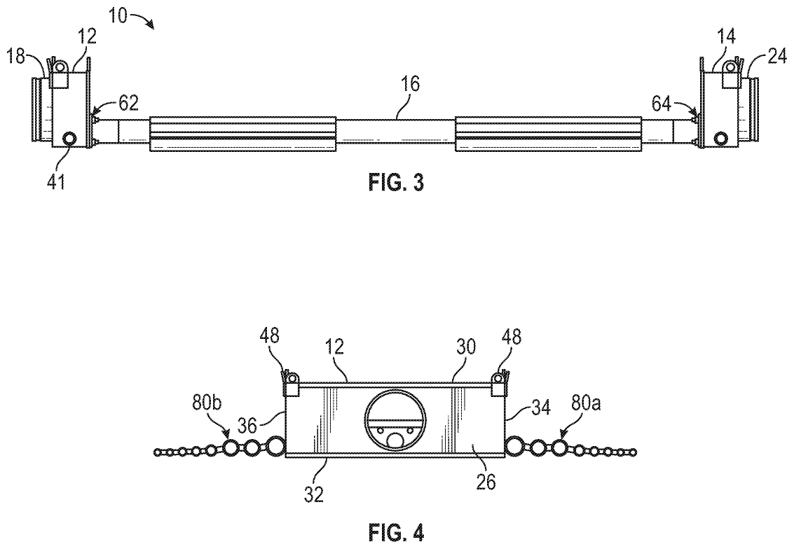

As best shown in FIG. 3, the fluid outlets 20 are formed in the rear wall 28 of the first manifold 12 near the bottom all 32. This allows the tubes 16 to be connected to the first manifold 12 and the second manifold 14 so the tubes 16 maintain a low profile to facilitate the passage of many vehicles over the roadway crossover apparatus 10,

The walls of the first manifold 12 and the second manifold 14 are desirably fabricated of a light weight metal. As an example, the walls of the first manifold 12 and the second manifold 14 may be fabricated of steel having a thickness of about 11 gauge. The type and thickness of metal used to construct the first manifold 12 may be varied so long as the overall size and weight of the roadway crossover apparatus 10 is so two to four personnel can move the roadway crossover apparatus 10 between a transport vehicle and a location of use.

The first manifold 12 may include a plurality of rigid cross members 42 positioned in the fluid chamber 38, and extending from the front wall 26 to the rear wall 28 to provide structural support to the first manifold 12. The cross members 42 are connected to a front support member 44 connected to the front wall 26 and a rear support member 46 connected to the rear wall 28. The front support member 44 and the rear support member 46 can be angle iron extending the length of the front wall 26 and the rear wall 28, respectively. In one embodiment, the first manifold 12 may have four cross members 42 spaced along the length of the first manifold 12.

The first manifold 12 may further include a plurality of lift eyes 48. The lift eyes 48 are arranged to permit rods (not shown) to be inserted through the lift eyes 48 so the rods can be used by personnel to lift and transport the roadway crossover apparatus 10.

The first manifold 12 further includes a plurality of flag holders 50 positioned on the rear wall 28 of the first manifold 12 for supporting visibility flags 52. The visibility flags 52 identify the location of the rear wall 28 of the first manifold 12 and may be any suitable length.

FIG. 6 illustrates one of the tubes 16. To enhance the durability and portability of the roadway crossover apparatus 10, and to substantially eliminate the need for maintenance, the tubes 16 may be fabricated from a tubular polymeric material, such as high density polyethylene pipe. While the length, outer diameter, and wall thickness of the polyethylene pipe employed in the fabrication of the tubes 16 can vary widely, desirable results can be obtained when the polyethylene pipe employed in the fabrication of each of the tubes 16 has a length of about 10 feet, an outer diameter of about 4½ inches and a wall thickness of at least about ⅜ inch. However, the sizes and lengths of the tubular members 16 can be varied to accommodate various sized roadways and vehicles.

The tubes 16 may include a tube portion 54 and a flange portion 56. The tube portion 54 and the flange portion 56 may be constructed as separate parts then heat welded together. The flange portion 56 has a groove 58 (FIG, 5) to accommodate a seal 60.

The tubes 16 are arranged in a parallel and coplanar relationship with one another. In one embodiment, the tubes 16 are clamped to the first manifold 12 and the second manifold 14 with a first clamp assembly 62 and a second clamp assembly 64. Because the first clamp assembly 62 and the second clamp assembly 64 are identical in construction, only the first clamp assembly 62 will be describe in detail.

The first clamp assembly 62 includes a yoke 66 and a strap 68. The yoke 66 is an elongated plate 70 with a plurality of notches 72 in which the tubes 16 are received. The strap 68 is an elongated member with a plurality of first contact sections 74 and a plurality of second contact sections 76. The first contact sections 74 are configured to contact one side of the plate 70 of the yoke 66, and the second contact sections 76 are configured to be positioned in the notches 72 of the yoke 66 so the second contact sections 76 are flush with the other side of the plate 70 when the tubes 16 are disposed in the notches 72. With the tubes 16 disposed in a corresponding one of the notches 72 and the strap 68 positioned on the yoke 66 with the second contact sections 76 positioned in the notches 72 and the flange portion 56 of the tubes 16 positioned between the first clamp assembly 62 and the rear wall 28 of the first manifold 12, the yoke 66 and the strap 68 are connected to the rear wall 28 of the first manifold 12 with a plurality of fasteners 78, such as nut and bolt combinations.

As shown in FIGS. 2A and 2B, the plurality of tubes 16 includes two outermost tubes 16a and 16b, and the roadway crossover apparatus 10 further has at least one ramp assembly 80a connected to the outermost tube 16a and at least one ramp assembly 80b connected to the outermost tube 16b. In one embodiment, the roadway crossover 10 has a first pair of ramp assemblies 80a connected to the outermost tube 16a and a second pair of ramp assemblies 80b connected to the outermost tube 16b. To facilitate transport of the roadway crossover apparatus 10, the first pair of ramp assemblies 80a can be pivotally connected to the outermost polymeric tube 16a and the second pair of ramp assemblies 80b can be pivotally connected to the other outermost polymeric tube 18b.

In one embodiment, the ramp assemblies 80a and 80b include a pair of flexible lines 82 pivotally connected to the outermost tubes 16a and 16b, a plurality of tubes 84a-84d of descending diameter threaded on the flexible lines 82, and a plurality of spacers 88 threaded on the flexible lines 82 and positioned between the tubes 84a-84d. In one embodiment, the flexible lines 82 may be fabricated of wire cable having a thickness of about ⅜ inch with one end looped around the outermost tubes 16a and 16b. The thickness and manner of securing the flexible lines 82 to the outermost tube 1a and 16b may be varied. Like the tubes 16, the tubes 84a-84d may be may be fabricated from a tubular polymeric material, such as high density polyethylene pipe. The distal most tube 84d may be formed of a metal or otherwise weighted to anchor the ramp assemblies 80a and 80b when deployed as shown in FIGS. 1 and 2A.

FIG. 2B illustrates the ramp assemblies 80a and 80b folded onto the tubes 16 in a storage position.

Returning to FIG. 1, the roadway crossover apparatus 10 may include a mat 90 extended across at least a portion of the tubes 16 and the ramps assemblies 80a and 80b to increase traction over the tubes 16 and the ramp assemblies 80a and 80b. In one embodiment, the roadway crossover apparatus 10 includes two mats 90. The mats 90 may be fabricated on any suitable material, such as rubber.

From the above description, it is clear that the inventive concepts disclosed herein is well adapted to carry out the objects and to attain the advantages mentioned and those inherent in the inventive concepts disclosed herein. While preferred embodiments of the inventive concepts disclosed have been described for this disclosure, it will be understood that numerous changes may be made which will readily suggest themselves to those skilled in the art and which are accomplished within the scope and coverage of the inventive concepts disclosed and claimed herein.

What is claimed is:

1. A roadway crossover apparatus, comprising:
a first manifold having at least one fluid inlet and a plurality of fluid outlets;
a second manifold having a plurality of fluid inlets and at least one fluid outlet; and
a plurality of polymeric tubes, each polymeric tube having a first end fluidically connected to one of the fluid outlets of the first manifold and a second end fluidically connected to a corresponding one of the fluid inlets of the second manifold so the polymeric tubes extend between the first manifold and the second manifold with the first manifold and the second manifold spatially disposed relative to one another and the polymeric tubes spatially disposed relative to one another to permit a vehicle to pass over the polymeric tubes between the first manifold and the second manifold when the first manifold and the second manifold are positioned on a roadway, the polymeric tubes having angular deflection characteristics and memory which permit the polymeric tubes to be angularly deflected by pressures exerted thereon and restored to a substantially non-deflected position upon removal of such pressures.

2. The roadway crossover apparatus of claim 1, wherein the plurailty of polymeric tubes include two outermost polymeric tubes, and wherein the road crossing apparatus further comprises a first ramp apparatus connected to one of the outermost polymeric tubes and a second ramp apparatus connected to the other outermost polymeric tube.

3. The roadway crossover apparatus of claim 2, wherein first ramp apparatus is pivotally connected to one of the outermost polymeric tubes and the second ramp apparatus is pivotally connected to the other outermost polymeric tube.

4. The roadway crossover apparatus of claim 1, wherein the plurality of polymeric tubes include two outermost polymeric tubes, and wherein the road crossing apparatus further comprises a first pair of ramp assemblies connected to one of the outermost polymeric tubes and a second pair of ramp assemblies connected to the other outermost polymeric tube.

5. The roadway crossover apparatus of claim 4, wherein first pair of ramp assemblies is pivotally connected to one of the outermost polymeric tubes and the second pair of ramp assemblies is pivotally connected to the other outermost polymeric tube.

6. The roadway crossover apparatus of claim 1, wherein the first manifold has a front wall, a rear wall, a top wall, a bottom wall, and a first end wall and a second end wall defining a fluid chamber in fluidic communication with the fluid inlet and the fluid outlets, the fluid inlet extending through the front wall and the fluid outlets extending through the rear wall,
wherein the first manifold further comprises a plurality of rigid cross members positioned in the fluid chamber and extending from the front wall to the rear wall.

7. The roadway crossover apparatus of claim 6, wherein the first manifold is substantially rectangularly shaped.

8. The roadway crossover apparatus of claim 6, wherein the second manifold is substantially rectangularly shaped with a front wall, a rear wall, a top wall, a bottom wall, and a first end wall and a second end wall defining a fluid chamber in fluidic communication with the fluid inlets and the fluid outlet, the fluid inlets extending through the rear wall and the fluid outlet extending through the front wall,
wherein the first manifold further comprises a plurality of rigid cross members positioned in the fluid chamber and extending from the front wall to the rear wall.

9. The roadway crossover apparatus of claim 1, wherein the first end of each of the polymeric tubes is clamped to the first manifold and the second end of each of the polymeric tubes is clamped to the second manifold.

10. The roadway crossover apparatus of claim 1, wherein the first manifold has a front wall, a rear wall, a top wall, a bottom wall, and a first end wall and a second end wall defining a fluid chamber in fluidic communication with the fluid inlet and the fluid outlets, the fluid inlet extending through the front wall and the fluid outlets extending through the rear wall, wherein the first end of each of the polymeric tubes has a first flange and the second end of each of the polymeric tubes has a second flange, and wherein the road crossover apparatus further comprises a first clamp assembly connecting the first flange of the polymeric tubes to the rear wall of the first manifold and a second clamp assembly connecting the second flange of the polymeric tubes to the rear wall of the second manifold.

11. The roadway crossover apparatus of claim 10, wherein the first clamp apparatus comprises:
a yoke having a plurality of tube receiving notches in which the polymeric tubes, the yoke connected to the rear wall of the first manifold with the polymeric tubes disposed in a corresponding one of the tube receiving notches and the first flange of the polymeric tubes positioned between the yoke and the rear wall of the first manifold; and
a strap positioned over the tube receiving notches and connected to the rear wall of the first manifold to cooperate with the yoke to connect the first flange of the polymeric tubes to the rear wall of the first manifold.

12. The roadway crossover apparatus of claim 11, wherein the second clamp assembly comprises:
a yoke having a plurality of tube receiving notches in which the polymeric tubes, the yoke connected to the rear wall of the second manifold with the polymeric tubes disposed in a corresponding one of the tube receiving notches and the second flange of the polymeric tubes positioned between the yoke and the rear wall of the second manifold; and
a strap positioned over the tube receiving notches and connected to the rear wall of the second manifold to cooperate with the yoke to connect the second flange of the polymeric tubes to the rear wall of the second manifold.

13. The roadway crossover apparatus of claim 1, wherein the polymeric tubes are arranged in a parallel relationship to one another.

14. The roadway crossover apparatus of claim 13, wherein the polymeric tubes are arranged in a coplanar relationship.

15. The roadway crossover apparatus of claim 1, further comprising a rubber mat extending across at least a portion of the polymeric tubes.

16. The roadway crossover apparatus of claim 4 further comprising:
a first rubber mat extending across one of the ramp assemblies of the first pair of ramp assemblies, a portion of the polymeric tubes, and an opposing ramp assembly of the second pair of ramp assemblies; and
a second rubber mat extending across another ramp assembly of the first pair of ramp assemblies, a portion of the polymeric tubes, and an opposing ramp assembly of the second pair of ramp assemblies.
